(19) United States
(12) Patent Application Publication
(10) Pub. No.: US 2008/0061231 A1
(43) Pub. Date: Mar. 13, 2008

(54) NANOWIRE SCANNING PROBE MICROSCOPY PROBE FOR MOLECULAR RECOGNITION IMAGING

(76) Inventors: Danielle R. Chamberlin, Belmont, CA (US); Maozi Liu, Fremont, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/380,709

(22) Filed: Apr. 28, 2006

(51) Int. Cl. G12B 21/02

(52) U.S. Cl. 250/306

(57) ABSTRACT

A scanning probe microscopy (SPM) probe functionalized for use in molecular recognition imaging comprises a cantilever element, a nanowire, a catalyst nanoparticle, a probe molecule and an elongate, flexible linking molecule. The cantilever element has a crystalline growth surface at one end. The nanowire extends substantially orthogonally from the growth surface. The catalyst nanoparticle is located at the distal end of the nanowire, remote from the growth surface. The linking molecule extends between the catalyst nanoparticle and the probe molecule.

### BACKGROUND

Scanning probe microscopy (SPM) is a useful tool for detecting and imaging recognition events between biomolecule pairs such as antibody and antigen, ligand and protein, single-stranded DNA and its complementary strands, and even for measuring binding forces. However, traditional methods in which the tip of an SPM probe is coated with a ligand have suffered from a lack of molecular mobility and the existence of unspecific tip-surface adhesion forces.

A superior method for performing molecular recognition imaging is disclosed by Hinterdorfer et al. in Detection and Localization of Individual Antibody-Antigen Recognition Events By Atomic Force Microscopy, 93 PROC. NAT. ACAD. SCI., 3477-3481 (1996). In this method, long, flexible linking molecules each having a probe molecule at one end are attached to an SPM probe tip at a sufficiently low density that, on average, about one probe molecule has access to surface-bound receptors. This method of attaching the probe molecule to the SPM probe tip allows the probe molecule sufficient ability to orient itself and provides sufficient separation between the probe molecule and the probe tip to alleviate such problems as steric hindrance and the problems arising from probe tip-surface interactions. In addition, in U.S. Pat. No. 6,952,952, incorporated by reference, Hinterdorfer et al. describe a way of using a similar probe tip arrangement to perform molecular recognition imaging and topography measurements simultaneously. This allows binding events to be correlated with the physical features of the test sample.

The method described in U.S. Pat. No. 6,952,952 presents the challenge of preparing the probe tip so that, on average, one probe molecule is attached to the probe tip in a location near the distal end of the probe tip, remote from the cantilever. A conventional SPM probe tip is typically shaped like a pyramid with a polygonal or circular base. The distal end of the probe tip, remote from the cantilever arm from which the probe tip extends, is radiused. The radius of curvature is typically in the range from about 10 nm to about 60 nm. Consequently, the distal end of the probe tip has a substantial surface area.

The SPM probe tip is modified with a specific reagent such as ethanolamine or amino-propyltriethoxysilane to place reactive groups such as amines on the surface of the probe tip. A long, flexible linking molecule is attached at one end to a respective one of the reactive groups on the probe tip by an amine reactive group at one end of the linking molecule. The probe molecule is attached to the end of the linking molecule remote from the probe tip. The relatively large surface area and low aspect ratio of the SPM probe tip make it difficult to define the location on the probe tip of the point of attachment between the probe tip and the linking molecule. In addition, the relatively large surface area and low aspect ratio of the SPM probe tip make it difficult to control the number of linking molecules, and, hence, the number of probe molecules, attached to the probe tip. Consequently, multiple probe molecules may be attached to the probe tip. These difficulties impair the sensitivity and spatial resolution of the molecular imaging process.

What is needed, therefore, is an SPM probe having a probe tip structured such that it can be functionalized with a probe molecule attached by an elongate linking molecule in which the uncertainty in the position of the attachment point between the linking molecule and probe tip is reduced. What also is needed is an SPM probe having a probe tip structured such that it can be functionalized with a single probe molecule in which uncertainty in the number of probe molecules attached to the probe tip is reduced.

### BRIEF DESCRIPTION OF THE DRAWINGS

FIGS. 1A and 1B are respectively a schematic side view and a schematic bottom view showing an example of a functionalizable SPM probe in accordance with an embodiment of the invention.

FIG. 2 is a schematic side view showing an example of a functionalized SPM probe in accordance with an embodiment of the invention.

FIGS. 3A and 3B are respectively a schematic side view and a schematic bottom view showing an example of a functionalizable SPM probe in accordance with another embodiment of the invention.

FIG. 4 is a schematic side view showing an example of a functionalized SPM probe in accordance with another embodiment of the invention.

FIGS. 5A-5D are schematic front views illustrating a first example of a process in accordance with an embodiment of the invention for functionalizing a functionalizable SPM probe in accordance with an embodiment of the invention.

FIGS. 6A and 6B are schematic front views illustrating a second example of a process in accordance with an embodiment of the invention for functionalizing a functionalizable SPM probe in accordance with an embodiment of the invention.

FIG. 7 is a schematic drawing illustrating an embodiment of a method in accordance with an embodiment of the invention of using an example of a functionalized SPM probe in accordance with an embodiment of the invention to perform molecular recognition imaging or simultaneous molecular recognition imaging and topography measurement.

FIGS. 8A-8H are schematic drawings illustrating an example of a process that may be used to fabricate embodiments of the functionalizable SPM probe shown in FIGS. 1A and 1B or the functionalizable SPM probe shown in FIGS. 3A and 3B.

FIGS. 9A and 9B are schematic drawings illustrating part of a process that may alternatively be used to fabricate embodiments of the functionalizable SPM probe shown in FIGS. 1A and 1B.

FIG. 10 are schematic drawings illustrating part of a process that may be used to fabricate embodiments of the functionalizable SPM probe shown in FIGS. 1A and 1B or the functionalizable SPM probes shown in FIGS. 3A and 3B.

### DETAILED DESCRIPTION

In accordance with an embodiment of the invention, a scanning probe microscopy (SPM) probe that is functionalizable for use in molecular recognition imaging comprises a cantilever element, a nanowire and a catalyst nanoparticle. The cantilever element has a crystalline growth surface at one end. The nanowire comprises nanowire material and extends substantially orthogonally from the growth surface. The catalyst nanoparticle is located at the distal end of the nanowire, remote from the growth surface. The catalyst nanoparticle comprises a material having a greater tendency to bond with one end of an elongate, flexible linking molecule than the nanowire material.

The nanowire and catalyst nanoparticle constitute at least part of the probe tip of the functionalizable SPM probe. The functionalizable SPM probe is functionalizable in the sense that its probe tip is structured to enable the catalyst nanoparticle that constitutes the distal end of the probe tip of the SPM probe to be selectively functionalized with a single probe molecule attached to the catalyst nanoparticle by an elongate, flexible linking molecule that extends between the probe molecule and the catalyst nanoparticle. The linking molecule comprises at one end a moiety capable of bonding with the catalyst nanoparticle in preference to the nanowire. The probe molecule is attached to the other end of the linking molecule, remote from the catalyst nanoparticle.

Functionalizing the SPM probe with a probe molecule located at the distal end of an elongate linking molecule allows a scanning probe microscope in which the SPM probe is mounted to detect an interaction between the probe molecule and a target molecule on the surface of a test sample, and therefore to perform molecular recognition imaging. Typical target molecules are antibodies, antigens, DNA, RNA, oligonucleotides, peptides, proteins, receptors, enzymes, ligands, polymers, carbohydrates and small molecules such as biotins. In some cases, the target molecule is a cell, a bacterium or a virus. The probe molecule is any molecule capable of forming a pair with the target molecule. In an example in which the target molecule is an antibody, the probe molecule is an antigen, and vice versa. In an example in which the target molecule is a protein, the probe molecule is a ligand and vice versa. In an example in which the target molecule is a DNA molecule, the probe molecule is a DNA molecule complementary to the DNA target molecule.

In accordance with another embodiment of the invention, an SPM probe functionalized for use in molecular recognition imaging comprises a cantilever element, a nanowire, a catalyst nanoparticle, a probe molecule and an elongate, flexible linking molecule. The cantilever element has a crystalline growth surface at one end. The nanowire extends substantially orthogonally from the growth surface. The catalyst nanoparticle is located at the distal end of the nanowire, remote from the growth surface. The linking molecule extends between the catalyst nanoparticle and the probe molecule.

Current fabrication technology allows the nanowire that constitutes part of the probe tip to have a diameter as small as about 5 nm and a length of the order of micrometers. The catalyst nanoparticle at the distal end of the nanowire is similar in diameter to the nanowire. The small size of the catalyst nanoparticle, together with the greater tendency of the linking molecule to bond with the catalyst nanoparticle than with the nanowire ensures that the linking molecule bonds to the catalyst nanoparticle rather than the nanowire. The structure just described localizes the attachment point between the linking molecule and the probe tip to the surface of the catalyst nanoparticle at the distal end of the nanowire. Consequently, uncertainty in the position of the attachment point between the linking molecule and probe tip is small. Moreover, the structure just described is capable of being functionalized such that more than zero but no more than one linking molecule is attached to the catalyst nanoparticle. Thus, uncertainty in the number of probe molecules attached to the probe tip is small.

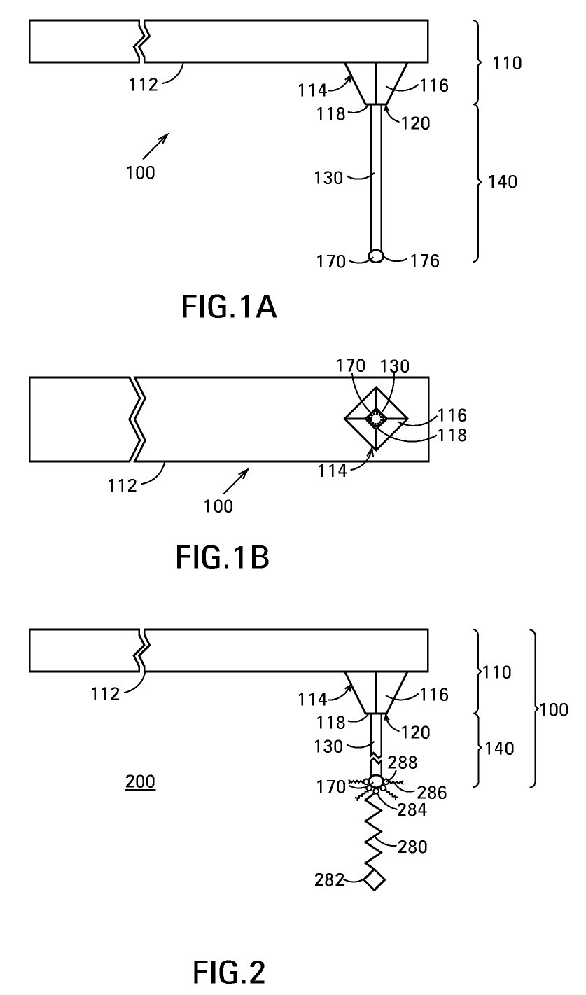

FIGS. 1A and 1B are respectively a schematic side view and a schematic bottom view showing an example of a scanning probe microscopy (SPM) probe 100 in accordance with an embodiment of the invention. SPM probe 100 is functionalizable for use in molecular recognition imaging. SPM probe 100 is composed of a cantilever element 110 having a crystalline growth surface 120 at one end, a nanowire 130 extending substantially orthogonally from growth surface 120 and a catalyst nanoparticle 170 at the distal end of the nanowire, remote from growth surface 120. Catalyst nanoparticle 170 comprises a material having a greater tendency to bond with one end of an elongate, flexible linking molecule than the nanowire material constituting nanowire 130. A growth surface that is closer to one end of the cantilever element than to the middle of the cantilever element will be regarded as being located at one end of the cantilever element.

Nanowire 130 and catalyst nanoparticle 170 collectively constitute the probe tip 140 of SPM probe 100. Probe tip 140 can be functionalized with a probe molecule (not shown in FIGS. 1A and 1B) coupled to catalyst nanoparticle 170 by an elongate, flexible linking molecule (not shown in FIGS. 1A and 1B) that extends between the catalyst nanoparticle and the probe molecule. This localizes the attachment point between one end of the linking molecule and probe tip 140 to the surface 176 of catalyst nanoparticle 170. Probe tip 140 can be functionalized by a process that ensures that more than zero but no more than one probe molecule is attached to the probe tip.

A crystalline growth surface such as crystalline growth surface 120 is a defined crystalline plane of the semiconductor material underlying the growth surface. In typical embodiments, the growth surface is the (111) crystalline plane of the underlying semiconductor material. A silicon nanowire grown on a silicon (111) crystalline plane will grow epitaxial, i.e., the crystallographic orientation of growth surface will be imposed on the nanowire, and the nanowire will grow in a direction substantially orthogonal to the growth surface. Typically, a nanowire will grow in a direction within±10° of the orthogonal direction. Hence, a nanowire grown on a growth surface disposed parallel to the cantilever element will extend substantially orthogonally to the growth surface, and, hence, will additionally extend substantially orthogonally to the cantilever element.

In other embodiments, the growth surface is a (100) crystalline plane or a (110) crystalline plane of the underlying semiconductor material. It is typically more difficult to grow a silicon nanowire with good material quality on a silicon growth surface that is the (100) crystalline plane or the (110) crystalline plane than on a silicon growth surface that is the (111) crystalline plane. However, the (100) crystalline plane and/or the (110) crystalline plane can give better material quality than the (111) crystalline plane in nanowires grown from semiconductor materials other than silicon.

In functionalizable SPM probe 100, cantilever element 110 is composed of a cantilever arm 112 and a frusto-pyramidal probe tip base 114 located at one end of cantilever arm 112. As used in this disclosure, the term frusto-pyramidal encompasses frusto-conical, a cone being a pyramid having a base with an infinite number of sides. A probe tip base that is closer to one end of cantilever arm 112 than to the middle of cantilever arm 112 will be regarded as being at one end of cantilever arm 112. Cantilever arm 112 is attached to the host scanning probe microscope (not shown) at or adjacent its end remote from probe tip 140.

Probe tip base 114 has crystalline side facets, an exemplary one of which is shown at 116, and, at its distal end, remote from cantilever arm 112, a crystalline end facet 118. In this first embodiment, end facet 118 provides growth surface 120, i.e., nanowire 130 extends from end facet 118. End facet 118 is substantially parallel to cantilever arm 112, i.e., end facet 118 is parallel to cantilever arm 112 typically within±10°. End facet 118 is typically less than about 0.01 μm² in area.

In a typical embodiment, a monolithic, single-crystal semiconductor atomic force microscope (AFM) probe having a frusto-pyramidal single-crystal silicon probe tip is used as cantilever element 110. Such monolithic, single-crystal semiconductor AFM probes are sold by NanoWorld AG of Neuchâtel, Switzerland. In such an AFM probe, the cantilever arm and probe tip are respective portions of a single piece of single-crystal silicon. In embodiments in which cantilever element 110 is electrically conducting, the single-crystal silicon is doped with a suitable dopant such as arsenic. In other embodiments, cantilever arm 112 and probe tip base 114 are separate components joined together. In such embodiments, the material of cantilever arm 112 need not be a semiconductor.

Nanowire 130 extends substantially orthogonally from growth surface 120 provided by crystalline end facet 118 at the distal end of probe tip base 114, i.e., nanowire 130 extends in a direction typically within±10° of the direction orthogonal to end facet 118. Typically, the material of nanowire 130 is a single-crystal semiconductor material, such as a single-crystal group IV semiconductor, e.g., silicon (Si); a single-crystal group III-V semiconductor, e.g., gallium arsenide (GaAs); or a single-crystal group II-VI semiconductor, such as zinc oxide (ZnO). In embodiments in which nanowire 130 is electrically conducting, the single-crystal semiconductor material of the nanowire is doped with a suitable dopant. An alternative nanowire material of which nanowire 130 can be composed is silicon dioxide (SiO₂).

As will be described in more detail below, nanowire 130 is grown from catalyst nanoparticle 170 deposited on growth surface 120. Throughout the growth process, catalyst nanoparticle 170 remains at the distal end of the nanowire, remote from cantilever element 110, and is therefore located at the distal end of the nanowire at the end of the growth process. Catalyst nanoparticle 170 is a somewhat oblate spheroid. The material of catalyst nanoparticle 170 is an alloy of the material of nanowire 130 and a catalyst metal. The material of catalyst nanoparticle 170 has a greater tendency to bond with one end of an elongate, flexible linking molecule than the nanowire material of nanowire 130.

FIG. 2 is a schematic side view showing an example of a functionalized scanning probe microscopy (SPM) probe 200 in accordance with an embodiment of the invention. SPM probe 200 is functionalized with a probe molecule attached to the probe tip of the SPM probe by an elongate, flexible linking molecule so that SPM probe 200 can be used to perform molecular recognition imaging.

SPM probe 200 is composed of cantilever element 110 having crystalline growth surface 120 at one end, nanowire 130 extending substantially orthogonally from growth surface 120, catalyst nanoparticle 170 at the distal end of the nanowire, remote from growth surface 120, a probe molecule 282 and an elongate, flexible linking molecule 280 that extends between catalyst nanoparticle 170 and probe molecule 282. Cantilever element 110, growth surface 120, nanowire 130 and catalyst nanoparticle 170 collectively constitute SPM probe 100 described above with reference to FIGS. 1A and 1B. Accordingly, SPM probe 100 will not be described again here.

Linking molecule 280 comprises a bonding moiety 284 at its end adjacent catalyst nanoparticle 170. Bonding moiety 284 is typically a thiol group (—SH). In other embodiments, bonding moiety 284 is a selenol group (—SeH), a disulfide group (—S—S—R) or a diselenide group (—Se—Se—R), where R is any alkyl chain or aromatic group. SPM probe 200 additionally comprises coating molecules, an exemplary one of which is shown at 286. The coating molecules will also be referred to collectively as coating molecules 286. Coating molecules 286 are shorter than linking molecule 280. Each coating molecule comprises a bonding moiety 288 at its end adjacent catalyst nanoparticle 170. Bonding moiety 288 is typically a thiol group (—SH). In other embodiments, bonding moiety 288 is a selenol group (—SeH), a disulfide group (—S—S—R) or a diselenide group (—Se—Se—R), where R is any alkyl chain or aromatic group. Bonding moiety 288 is typically the same as bonding moiety 284 of linking molecule 280, but can be different from bonding moiety 284. Coating molecules 286 and linking molecule 280 collectively form a self-assembling monolayer that coats the external surface 176 (FIG. 1A) of catalyst nanoparticle 170.

In the example shown, linking molecule 280 is a molecule of a linear polymer. Linear polymers are elongate and flexible. Other types of molecules that are elongate and flexible can also be used. In an example, linking molecule 280 is a molecule of a polyethylene glycol (H(OCH₂CH₂)ₙ—OH, where n is the number of oxyethlyene repeat units), often referred to as PEG. The number n of oxyethane repeat units determines the length of linking molecule 280. When used in the molecular recognition imaging process described by Hinterdorfer et al. in above-mentioned U.S. Pat. No. 6,952,952, which is incorporated by reference, the length of the linking molecule is chosen to be comparable with the amplitude of the oscillation imposed on the probe tip 140 of SPM probe 200. At such a length of linking molecule 280, the bond between the target molecule (not shown) and probe molecule 282 at the distal end of linking molecule 280 will be broken each time the probe tip is at its maximum distance from the surface on which the target molecule is located. The length of linking molecule 280 is typically in the range from several nanometers to a few tens of nanometers. A polyethylene glycol in which n=30 has a length of a few tens of nanometers.

Alternatively, linking molecule 280 can be a polypeptide. A polypeptide comprises a series of amino acid molecules covalently linked together by peptide bonds. The sequence of the amino acid molecules in the polypeptide can be predetermined by the user in accordance with experimental requirements. At one end of the polypeptide is a cysteine (C₃H₇NO₂S) molecule, which comprises a thiol group, that provides bonding moiety 284. At the other end of the polypeptide is a —COOH group or an —NH₂ group to which probe molecule 282 can easily be attached. The length of the linking molecule is determined by the number of constituent amino acids.

Probe molecule 282 is any molecule capable of forming a pair with a target molecule of interest. Examples of pairs include antibody-antigen, streptavidin-biotin, donor-receptor, protein-ligand, DNA-cDNA, etc.

Coating molecules 286 are aliphatic molecules considerably shorter than linking molecule 280. In one example, coating molecules 286 are molecules of alkanethiol such as n-hexane thiol (C₆H₁₃SH). N-pentane thiol (C₅H₁₁SH), n-heptane thiol (C₇H₁₅SH) or another suitable alkanethiol in which the number of carbon atoms can be as many as eighteen (i.e., C₁₈H₃₇SH) may also be used. In another example, coating molecules 286 are molecules of a thiolated polyethylene glycol (HS—(CH₂)ₘ—(OCH₂CH₂)ₙ—OH), where m is an integer ranging from 3 to 11, n is an integer greater than unity, and the values of m and n determine the length of the coating molecule. At one end, each coating molecule 286 has a thiol group that provides bonding moiety 288. Alternatively, each coating molecule may have a disulfide group, a selenol group or a diselenide group instead of the thiol group.

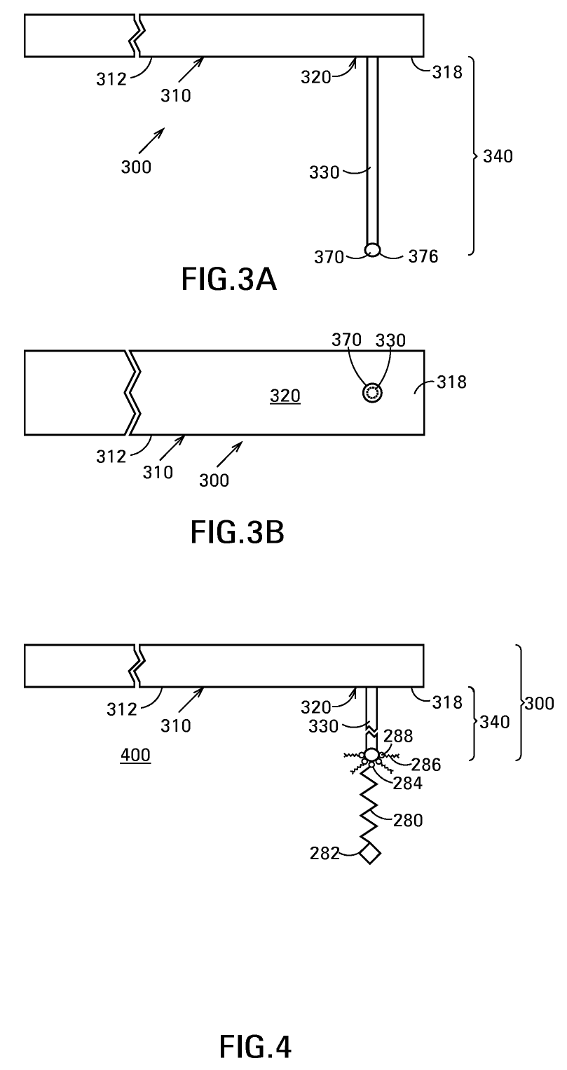

FIGS. 3A and 3B are respectively a schematic side view and a schematic bottom view showing an example of an SPM probe 300 in accordance with another embodiment of the invention. SPM probe 300 is functionalizable for use in molecular recognition imaging. SPM probe 300 is composed of a cantilever element 310 having a crystalline growth surface 320 at one end, a nanowire 330 extending substantially orthogonally from growth surface 320 and a catalyst nanoparticle 370 at the distal end of the nanowire, remote from growth surface 320. Catalyst nanoparticle 370 comprises a material having a greater tendency to bond with one end of an elongate, flexible linking molecule than the nanowire material constituting nanowire 330. A growth surface that is closer to one end of the cantilever element than to the middle of the cantilever element will be regarded as being located at one end of the cantilever element.

Nanowire 330 and catalyst nanoparticle 370 collectively constitute the probe tip 340 of SPM probe 300. Probe tip 340 can be functionalized with a probe molecule (not shown in FIGS. 3A and 3B) coupled to catalyst nanoparticle 370 by an elongate, flexible linking molecule (not shown in FIGS. 3A and 3B) that extends between the catalyst nanoparticle and the probe molecule. This localizes the attachment point between one end of the linking molecule and probe tip 340 to the surface 376 of catalyst nanoparticle 370. Probe tip 340 can be functionalized by a process that ensures that more than zero but no more than one probe molecule is attached to the probe tip.

In functionalizable SPM probe 300, a cantilever arm 312 is used as cantilever element 310. Cantilever arm 312 is attached to the host SPM (not shown) at or adjacent its end remote from probe tip 340.

In the example shown, cantilever arm 312 is an elongate piece of single-crystal semiconductor material in which one of the crystalline planes of the semiconductor material coincides with a major external surface 318 of the cantilever arm. In the example shown in FIGS. 3A and 3B, the crystalline external surface 318 of cantilever arm 312 that coincides with one of the crystalline planes of the semiconductor material of cantilever arm 312 provides growth surface 320, i.e., nanowire 330 extends from external surface 318. In an embodiment, external surface 318 is substantially parallel to the longitudinal axis of cantilever arm 312, i.e., external surface 318 is parallel to the longitudinal axis of cantilever arm 312 typically within±10°.

In a typical embodiment, a tipless, monolithic, single-crystal semiconductor AFM probe is used as cantilever element 310. Such tipless, monolithic, single-crystal semiconductor AFM probes are sold by NanoWorld AG of Neuchâtel, Switzerland. Such tipless AFM probe is a single piece of single-crystal silicon. In other embodiments (not shown), the material of the cantilever element is not a semiconductor. In such embodiments, the cantilever element has at one end a layer of crystalline semiconductor material on at least part of one of its major external surfaces. The exposed surface of the semiconductor material provides growth surface 320.

Nanowire 330 extends substantially orthogonally from growth surface 320 provided by the crystalline external surface 318 of cantilever arm 312, i.e., nanowire 330 extends in a direction typically within±10° of the direction orthogonal to external surface 318. Typically, the material of nanowire 330 is a single-crystal semiconductor material, such as a single-crystal group IV semiconductor, e.g., silicon (Si); a single-crystal group ITT-V semiconductor, e.g., gallium arsenide (GaAs); or a single-crystal group II-VI semiconductor, such as zinc oxide (ZnO). An alternative nanowire material of which nanowire 330 can be composed is silicon dioxide (SiO₂).

As will be described in more detail below, nanowire 330 is grown from catalyst nanoparticle 370 deposited on growth surface 320. Throughout the growth process, catalyst nanoparticle 370 remains at the distal end of the nanowire, remote from cantilever element 310, and is therefore located at the distal end of the nanowire at the end of the growth process. Catalyst nanoparticle 370 is a somewhat oblate spheroid. The material of catalyst nanoparticle 370 is an alloy of the material of nanowire 330 and a catalyst metal. The material of catalyst nanoparticle 370 has a greater tendency to bond with one end of an elongate, flexible linking molecule than the nanowire material of nanowire 330.

FIG. 4 is a schematic side view showing an example of a functionalized scanning probe microscopy (SPM) probe 400 in accordance with another embodiment of the invention. SPM probe 400 is functionalized with a functional group attached to the probe tip of the SPM probe by an elongate, flexible linking molecule so that SPM probe 400 can be used to perform molecular recognition imaging.

SPM probe 400 is composed of cantilever element 310 having crystalline growth surface 320 at one end, nanowire 330 extending substantially orthogonally from growth surface 320, catalyst nanoparticle 370 at the distal end of the nanowire, remote from growth surface 320, probe molecule 282 and elongate, flexible linking molecule 280 that extends between catalyst nanoparticle 370 and probe molecule 282. Cantilever element 310, growth surface 320, nanowire 330 and catalyst nanoparticle 370 collectively constitute SPM probe 300 described above with reference to FIGS. 3A and 3B. Accordingly, SPM probe 300 will not be described again here. Linking molecule 280 and probe molecule 282 are described above with reference to FIG. 2 and will not be described again here. FIG. 4 also shows linking molecule 280 attached to catalyst nanoparticle 370 by bonding moiety 284 and catalyst nanoparticle 370 coated with coating molecules 286 having bonding moieties 288 at one end. Bonding moiety 284, coating molecules 286 and bonding moiety 288 are described above with reference to FIG. 2 and will not be described again here.

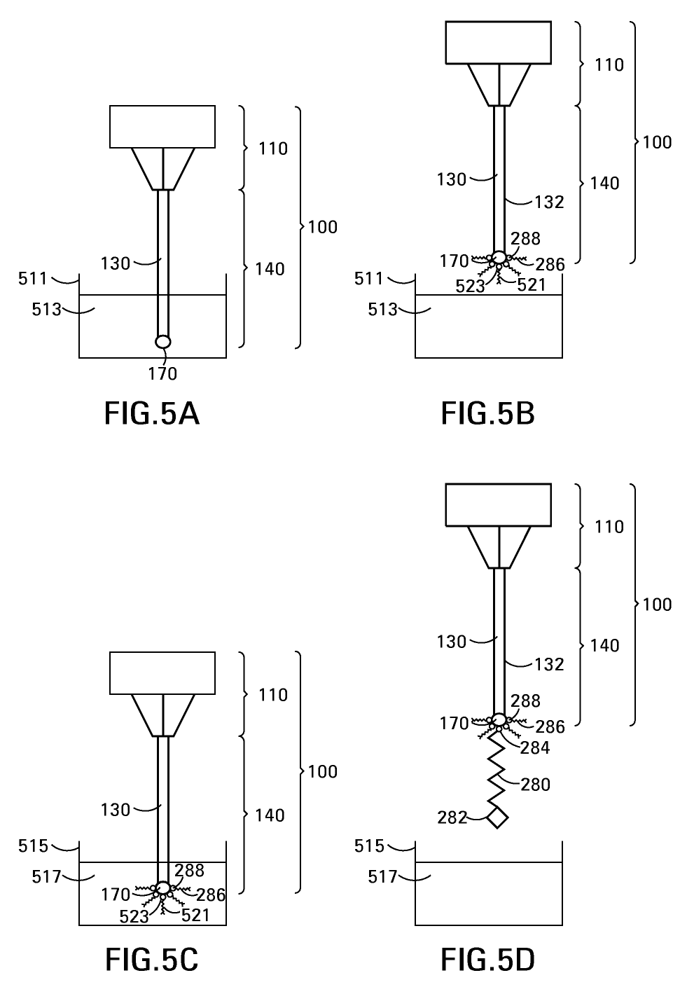

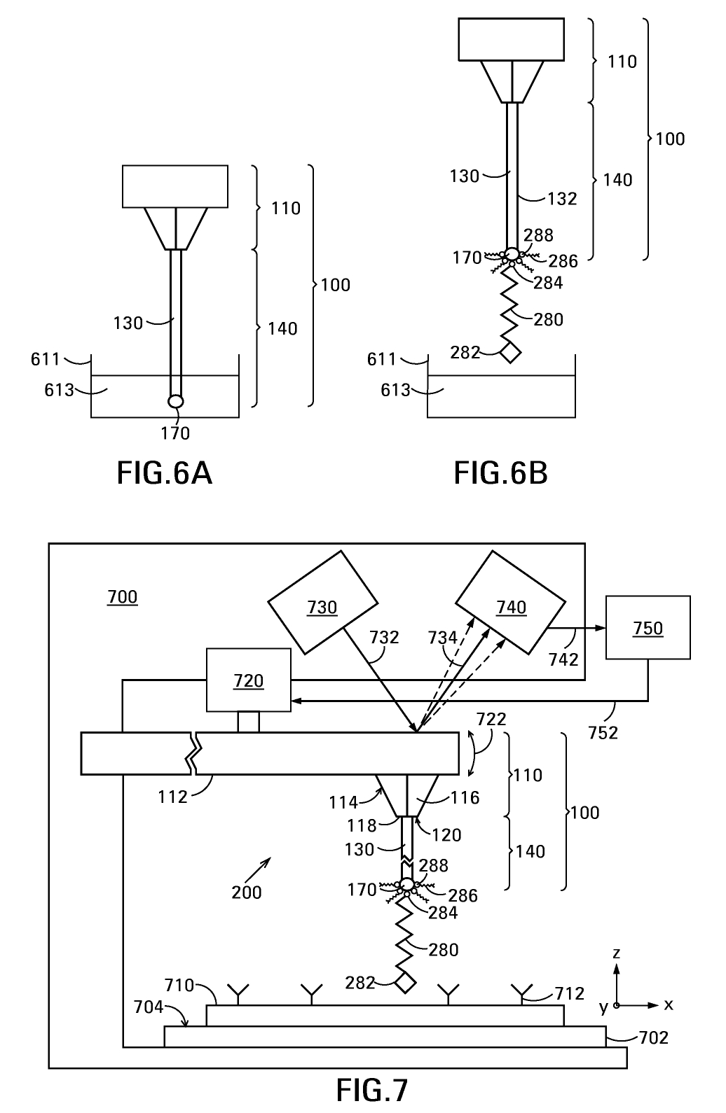

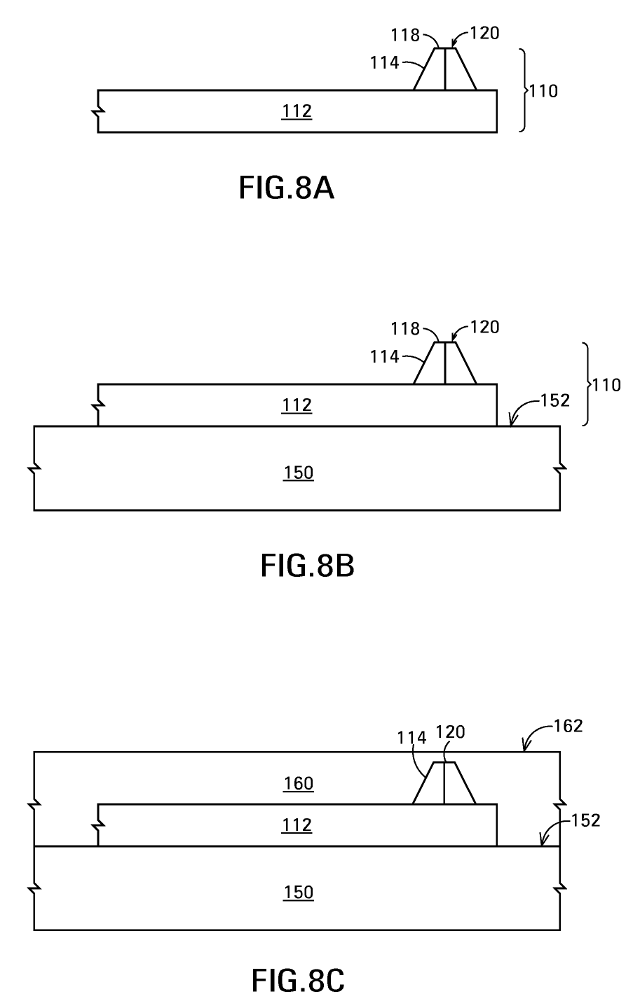

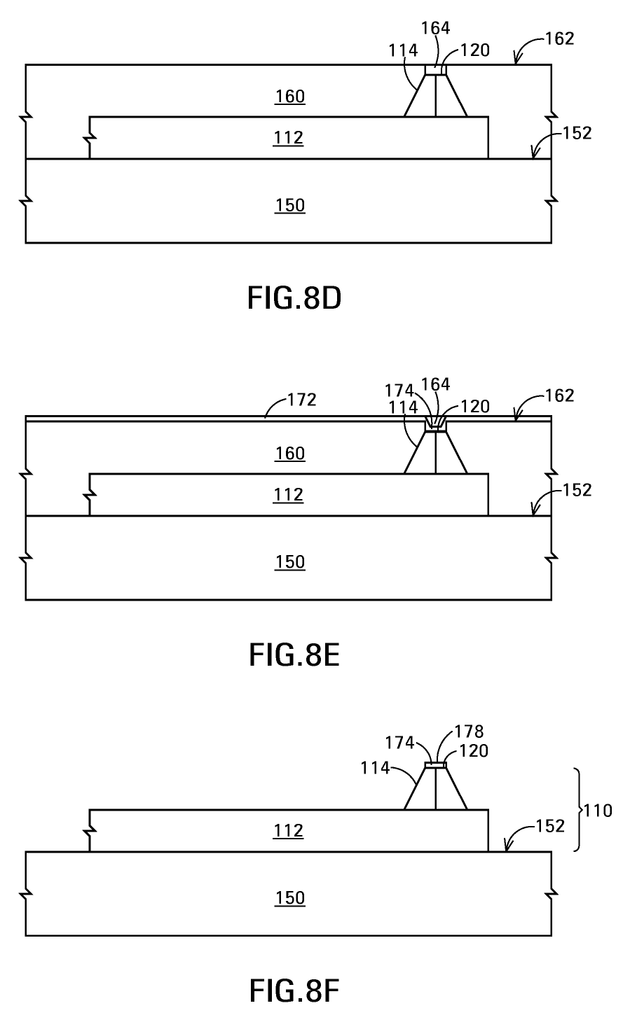

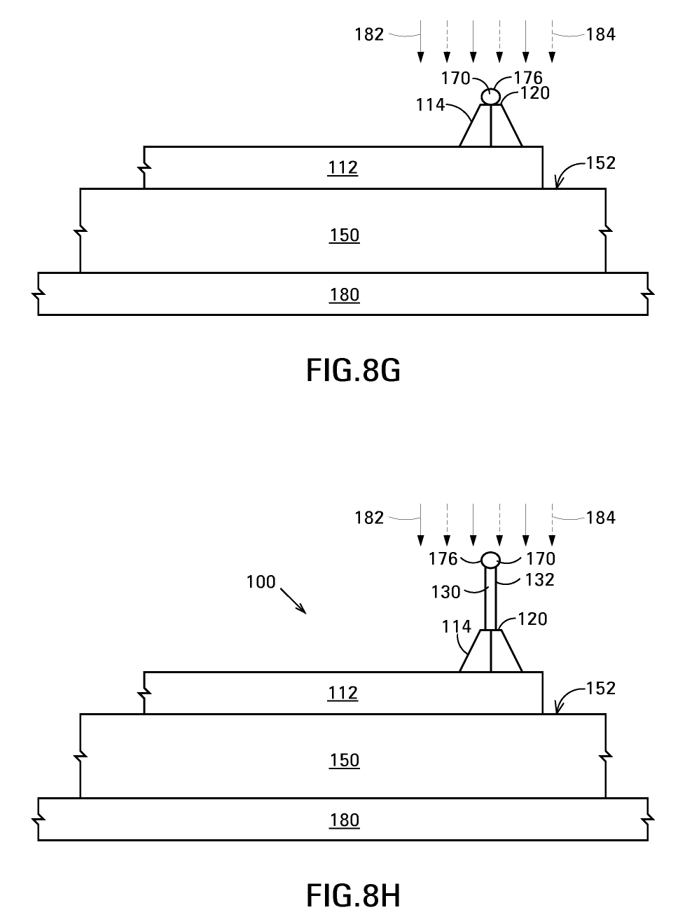

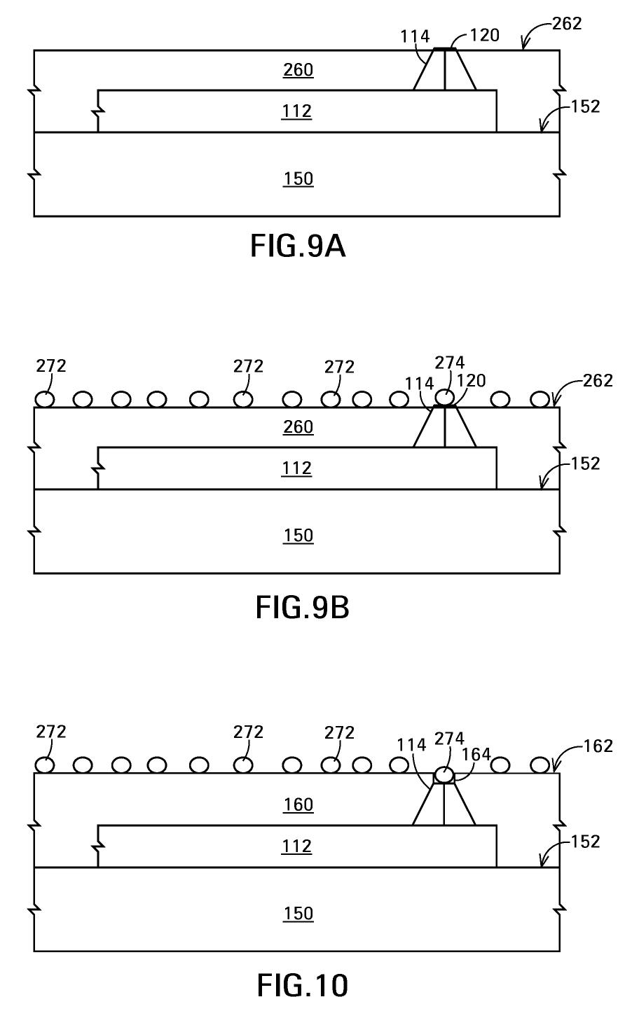

An example of a process that may be used to fabricate functionalizable SPM probe 100 described above with reference to FIGS. 1A and 1B or functionalizable SPM probe 300 described above with reference to FIGS. 3A and 3B will be described below with reference to FIGS. 8A-8H. Variations on the process described below with reference to FIGS. 8A-8H will be described below with reference to FIGS. 9A, 9B and 10. Examples of a process that may be used to functionalize functionalizable SPM probe 100 to form functionalized SPM probe 200 will be described next with reference to FIGS. 5A-5D and FIGS. 6A and 6B. In these processes, a functionalizable SPM probe having a probe tip with a catalyst nanoparticle at its distal end, described above, is provided, and a probe molecule is coupled to the catalyst nanoparticle by an elongate, flexible linking molecule attached at one end to the catalyst nanoparticle and attached its other end to the probe molecule.

The functionalizing processes described below may be performed on functionalizable SPM probes that form all or part of a probe wafer, as will be described below, or may be performed on individual SPM probes. The functionalizing process may be performed by the manufacturer of the functionalizable SPM probes, by the user of the functionalized SPM probes or by a third party. Any of these entities may perform the method on the wafer scale, on the partial wafer scale or on the individual scale. The process will be described with reference to examples in which functionalizable SPM probe 100 is functionalized to form functionalized SPM probe 200. The process may additionally be used to functionalize functionalizable SPM probe 300 to form a respective functionalized SPM probe 400.

A first example of the process will now be described with reference to FIGS. 5A-5D. This example may be employed in an embodiment in which the coating molecules and the linking molecules are soluble in different solvents. FIG. 5A shows a container 511 containing a solution 513 of coating molecules (not shown). In solution 513, the coating molecules are short aliphatic molecules as described above and are dissolved in any suitable solvent. In an example in which the coating molecules are molecules of an alkanethiol (e.g., hexanethiol C₆H₁₄SH), solution 513 is a 1 mM solution of the alkanethiol in ethanol (C₂H₅0H). Alternatively, a drop of solution 513 may be placed on a surface. Functionalizable SPM probe 100 is positioned relative to solution 513 such that catalyst nanoparticle 170 is immersed in solution 513. Immersing catalyst nanoparticle 170 in solution 513 typically also results of part of nanowire 130 being immersed in the solution, as shown in FIG. 5A. The immersion time of catalyst nanoparticle 170 in solution 513 is typically in the range from about 20 minutes to overnight. The coating molecules deposited on catalyst nanoparticle 170 form a self-assembling monolayer that coats the external surface of the nanoparticle.

Functionalizable SPM probe 100 is then withdrawn from solution 513, as shown in FIG. 5B. An exemplary one of the coating molecules coating catalyst nanoparticle 170 is shown at 286 and its thiol moiety is shown at 288. Another of the coating molecules coating catalyst nanoparticle 170 is shown at 521 and its thiol moiety is shown at 523. Immersing catalyst nanoparticle 170 and nanowire 130 in solution 513 typically additionally results in a few of the coating molecules being physically adsorbed by nanowire 130. Since the adsorption is weak, such coating molecules can be removed from nanowire 130 by immersing catalyst nanoparticle 170 and nanowire 130 in pure ethanol (not shown) and then withdrawing the catalyst nanoparticle and nanowire from the ethanol. Functionalizable SPM probe 100 is then left to air dry. Alternatively, the SPM probe may be blown dry using a stream of dry nitrogen (N₂) or another suitable gas.

FIG. 5C shows a container 515 containing a solution 517 of elongate, flexible linking molecules each of which has a bonding moiety at one end. Optionally, each of the linking molecules has a probe molecule at its other end, remote from the bonding moiety. In an example in which the coating molecules are molecules of an alkanethiol (e.g., hexanethiol C₆H₁₃SH), solution 517 is a 1 mM solution of the alkanethiol in ethanol (C₂H₅OH), and the thiol moiety provides the bonding moiety. Alternatively, in embodiments in which a functionalizable SPM probe is functionalized individually, a drop of solution 517 is placed on a surface. Functionalizable SPM probe 100 is positioned relative to solution 513 such that catalyst nanoparticle 170 is immersed in solution 517. Immersing catalyst nanoparticle into solution 517 typically also results of part of nanowire 130 being immersed in the solution, as shown in FIG. 5C.

While catalyst nanoparticle 170 is immersed on solution 517, an exchange reaction takes place in which coating molecule 521 is replaced by one of the linking molecules in the self-assembled monolayer coating the surface of catalyst nanoparticle 170. The concentration of linking molecules in solution 517 and the immersion time of catalyst nanoparticle 170 in solution 517 are chosen so that the exchange reaction takes place with respect to more than zero but no more than one of the linking molecules in solution 517. In an example, the immersion time is in the range from about 20 minutes to two hours. The concentration of linking molecules in solution 517 is typically in the range from 0.1 mM to 5 mM. The immersion time typically depends inversely on the concentration of the linking molecules in solution 517.

The SPM probe is then withdrawn from solution 517, as shown in FIG. 5D. Catalyst nanoparticle 170 is covered with a monolayer composed of coating molecules 286 and single linking molecule 280. Single linking molecule 280 and its bonding moiety 284 has replaced coating molecule 521 and its bonding moiety 523 (FIG. 5C) in the monolayer covering catalyst nanoparticle 170. The SPM probe can then be washed using an organic solvent, such as pure ethanol (C₂H₅OH) or acetonitrile (CH₃CN). The washing process removes any of the linking molecules physically adsorbed on the surface of nanowire 130 but does not remove linking molecule 280 attached to catalyst nanoparticle 170. The SPM probe is then left to air dry. Alternatively, the SPM probe may be blown dry using a stream of dry nitrogen (N₂) or another suitable gas.

In an embodiment in which solution 517 additionally comprises probe molecules attached to the linking molecules at the end of the linking molecules remote from the bonding moieties, the SPM probe fabricated by the process just described has probe molecule 282 coupled to catalyst nanoparticle 170 by linking molecule 280, as shown in FIG. 5D. In this embodiment, the above-described drying process completes fabrication of functionalized SPM probe 200.

In another embodiment, each of the linking molecules in solution 517 has a functional group (not shown) instead of probe molecule 282 attached to its end remote from bonding moiety 284. The functional group is any functional group capable of selectively interacting with probe molecule 282. Examples of the functional group include thiol (—SH), selenol (—SeH), primary amine (—NH₂), aldehyde (—CHO), carboxyl (—COOH), hydroxyl (—OH), biotin, streptavidin and avidin. In such an embodiment, the SPM probe fabricated by the process just described has the functional group coupled to catalyst nanoparticle 170 by linking molecule 280. The SPM probe tip is then subject to further processing in which the functional group is reacted with probe molecules to attach one of the probe molecules to the end of linking molecule 280 remote from catalyst nanoparticle 170 as probe molecule 282. In some of such reactions, probe molecule 282 attaches to the functional group at the end of linking molecule 280. In others of such reactions, probe molecule 282 is substituted for at least part of the functional group at the end of linking molecule 280. In yet others of such reactions, probe molecule 282 is attached to the end of linking molecule 280 through a specific interaction such as a biotin-streptavidin interaction or a biotin-avidin interaction. Attachment of probe molecule 282 completes the fabrication of functionalized SPM probe 200.

A second process example will now be described with reference to FIGS. 6A and 6B. This process may be employed in an embodiment in which the coating molecules and the linking molecules are soluble in a common solvent. FIG. 6A shows a container 611 containing a solution 613 comprising coating molecules and linking molecules. In solution 613, the coating molecules are short aliphatic molecules and the linking molecules are elongate, flexible molecules, both as described above, and are dissolved in any suitable solvent in which both are soluble. The ratio of the concentrations of the coating molecules and the linking molecules in solution 613 is set to ensure that the coating molecules and the linking molecules collectively form on catalyst nanoparticle 170 a self-assembling monolayer composed of more than zero but no more than one linking module. To achieve this result, the concentration of the linking molecules in the solution is typically several orders of magnitude less than that of the coating molecules. Factors such as the size of catalyst nanoparticle 170, the relative affinities of the coating molecules and the linking molecules for the material of catalyst nanoparticle 170, and the relative solubilities of the coating molecules and the linking molecules in the solvent are used to determine the ratio of the concentrations.

In an example in which the coating molecules are molecules of an alkanethiol (e.g., hexanethiol C₆H₁₃SH) and the linking molecules are molecules of a thiolated linear polymer, (e.g., thiolated polyethylene glycol (SH—(OCH₂CH₂)ₙ—OH) (PEG)), the solvent in solution 613 was ethanol (C₂H₅OH). In embodiments in which a functionalizable SPM probe is functionalized individually, container 611 may be omitted and a drop of solution 613 placed on a surface.

Functionalizable SPM probe 100 is positioned relative to solution 613 such that catalyst nanoparticle 170 is immersed in solution 613. Immersing catalyst nanoparticle 170 in solution 613 typically also results of part of nanowire 130 being immersed in the solution, as shown in FIG. 6A. The immersion time of catalyst nanoparticle 170 in solution 613 is typically in the range from about 20 minutes to two hours. The coating molecules and linking molecule deposited on catalyst nanoparticle 170 form a self-assembling monolayer that coats the external surface of the nanoparticle.

SPM probe 100 is then withdrawn from solution 613, as shown in FIG. 6B. Catalyst nanoparticle 170 is covered with a monolayer composed of the coating molecules and the single linking molecule. An exemplary one of the coating molecules coating catalyst nanoparticle 170 is shown at 286 and its thiol bonding moiety is shown at 288. The thiol bonding moiety of linking molecule 280 is shown at 284.

The SPM probe can then be washed using an organic solvent, such as pure ethanol (C₂H₅OH) or acetonitrile (CH₃CN). The washing process removes any of the linking molecules physically adsorbed on the surface of nanowire 130 but does not remove linking molecule 280 attached to catalyst nanoparticle 170. The SPM probe is then left to air dry. Alternatively, the SPM probe may be blown dry using a stream of dry nitrogen (N₂) or another suitable gas.

In an embodiment in which solution 613 additionally comprises probe molecules attached to the linking molecules at the end of the linking molecules remote from the bonding moieties, the SPM probe fabricated by the process just described has probe molecule 282 coupled to catalyst nanoparticle 170 by linking molecule 280, as shown in FIG. 6B. In this embodiment, the above-described drying process completes fabrication of functionalized SPM probe 200.

In another embodiment, each of the linking molecules in solution 613 has a functional group (not shown) instead of probe molecule 282 attached to its end remote from bonding moiety 284, as described above with reference to FIG. 5D. In such embodiment, after catalyst nanoparticle 170 has been immersed in solution 611, the functional group is coupled to catalyst nanoparticle 170 by linking molecule 280. The SPM probe tip is then subject to further processing in which the functional group is reacted with probe molecules to attach one of the probe molecules to the end of the linking molecule remote from catalyst nanoparticle 170 as probe molecule 282. In some reactions, probe molecule 282 attaches to the functional group at the end of linking molecule 280. In others reactions, probe molecule 282 is substituted for at least part of the functional group at the end of linking molecule 280. In yet others of such reactions, probe molecule 282 is attached to the end of linking molecule 280 through a specific interaction such as a biotin-streptavidin interaction or a biotin-avidin interaction. Attachment of probe molecule 282 completes the fabrication of functionalized SPM probe 200.

FIG. 7 is a schematic drawing illustrating the use of an example of functionalized SPM probe 200 to perform molecular recognition imaging or simultaneous molecular recognition imaging and topography measurement. A scanning probe (SP) microscope is schematically shown at 700. SP microscope 700 comprises an X-Y stage 702, an actuator 720, a light source 730, a light detector 740 and a processor 750. The end of the cantilever element 110 of functionalized SPM probe 200 remote from probe tip 140 is mounted in SP microscope 700.

X-Y stage 702 has a plane mounting surface 704 on which a test sample can be mounted. Mounting surface 704 defines a reference x-y plane. An example of a test sample mounted on the mounting surface 704 of X-Y stage 702 is shown at 710. Test sample 710 has target molecules on its major surface. An exemplary target molecule is shown at 712, and the target molecules will be referred to collectively as target molecules 712. X-Y stage 702 is operable to move test sample 710 in the x- and y-directions shown in FIG. 7.

Actuator 720 is coupled to the cantilever element 112 of SPM probe 200 and is operable to cause cantilever element 110 and, hence, the probe tip 140 of SPM probe 200, to oscillate in the z-direction, orthogonal to the mounting surface 704 of X-Y stage 702. The direction of oscillation is indicated by an arrow 722. While a mechanical link between actuator 720 and cantilever element 110 is shown, actuator 720 can alternatively be coupled to cantilever element electrostatically or magnetically.

Light source 730 comprises a laser (not shown) aligned to direct a narrow beam of light 732 towards the cantilever element 110 of SPM probe 200. Cantilever element 110 specularly reflects light beam 732 towards light detector 740 as light beam 734. Light detector 740 comprises a one- or two-dimensional array of light sensors (not shown) that collectively generate a position signal 742 that represents the position at which light beam 734 is incident on light detector 740. The position at which light beam 734 is incident on light detector 740 depends on the deflection of SPM probe 200.

Light detector 740 outputs position signal 742 to processor 750. Processor 750 generates a control signal 752 that controls actuator 720. In one aspect of the control of actuator 720, actuator 720 is controlled to set the imaging amplitude of the oscillation of probe tip 140 to be larger than the length of linking molecule 280 such that probe molecule 282 bonding with target molecule 712 will reduce the maximum deflection of probe tip 140 in the +z-direction. An imaging amplitude in the range from about 105% to about 150% of the length of linking molecule 280 is typical.

Functionalized SPM probe 200 mounted in SP microscope 700 is used in accordance with the method disclosed by Hinterdorfer et al. in above-mentioned U.S. Pat. No. 6,952,952 to perform molecular recognition imaging and, optionally, simultaneous topographic measurements on test sample 710. Processor 750 monitors how the positions in the z-direction of the maxima and the minima of the deflection of SPM probe 200 vary as X-Y stage 702 is operated to move test sample 710 relative to probe tip 140 in a raster scan. Monitoring the z-direction positions of the minima of the deflection of the SPM probe provides data from which the topographical measurements can be extracted. When X-Y stage 704 positions test sample 710 such that target molecule 712 is aligned with probe tip 140, probe molecule 282 bonds with target molecule 712. After probe molecule 282 has bonded to target molecule 712, probe tip 140 moving in the +z-direction away from test sample 710 extends linking molecule 280. Eventually linking molecule 280 reaches its full extent. Further motion of probe tip 140 in the +z-direction breaks the bond between probe molecule 282 and target molecule 712. The energy needed to break the bond changes the z-direction position the maximum of the deflection of SPM probe 200. Thus, monitoring the z-direction positions of the maxima of the deflection of SPM probe 200 provides data from which molecular recognition imaging information can be extracted. Further details of this method can be found in the above-mentioned U.S. Pat. No. 6,952,952.

FIGS. 8A-8H illustrate, and the following description describes, an example of a process that may be used to fabricate embodiments of functionalizable SPM probe 100 described above with reference to FIGS. 1A and 1B. In the example described, SPM probe 100 is fabricated on one of a number of AFM probes defined in a probe wafer (not shown). The AFM probe constitutes the cantilever element 110 of SPM probe 100, as described above. As SPM probe 100 is fabricated, SPM probes similar to SPM probe 100 are fabricated on the remaining cantilever elements in the probe wafer. Embodiments of functionalizable SPM probe 300 described above with reference to FIGS. 3A and 3B may also be fabricated using the same process. The process is based on the process disclosed by Yi et al. in U.S. patent application Ser. No. 11/351,511, incorporated by reference. The process can readily be adapted to fabricate an SPM probe individually.

Referring first to FIG. 8A, in the example of cantilever element 110 shown, cantilever arm 112 and probe tip base 114 are respective portions of a single-crystal silicon AFM probe. The end facet 118 of probe tip base 114 is substantially parallel to cantilever arm 112, as defined above, and is typically the (111) crystalline plane of the silicon of the probe tip base. Probe tip base 114 may alternatively be a suitably-shaped piece of single-crystal silicon mounted on cantilever arm 112. In such an embodiment, the end facet 118 of probe tip base 114 that provides growth surface 120 is the (111) crystalline plane of the silicon of the probe tip base so that the growth direction of nanowire 130 is defined as described above. In other embodiments, end facet 118 is a (100) or a (110) crystalline plane, although, as noted above, it is more difficult to grow silicon nanowires with good material quality on such crystalline planes than on the (111) crystalline plane. In an embodiment of the process in which SPM probes similar to SPM probe 300 described above with reference to FIGS. 3A and 3B are fabricated, cantilever element 310 is composed of cantilever arm 312, which is a tipless, single-crystal silicon AFM probe. At least part of the external surface 318 of cantilever arm 312 provides crystalline growth surface 320.

In specific examples, cantilever arm 112 and probe tip base 114 are the cantilever arm and probe tip, respectively, of a monolithic single-crystal AFM probe having a frusto-pyramidal single-crystal silicon probe tip sold by NanoWorld AG of Neuchâtel, Switzerland, and cantilever arm 212 is a tipless, monolithic single-crystal AFM probe sold by NanoWorld AG.

The probe wafer in which the cantilever elements including cantilever element 110 are defined typically has apertures extending between its major surfaces. The apertures make the probe wafer incompatible with the vacuum chucks used in some of the operations described below. At least to remedy this incompatibility, the probe wafer is temporarily mounted on the major surface 152 of a handle wafer 150 with growth surface 120 facing away from major surface 152, as shown in FIG. 8B. Handle wafer 150 is a wafer of conventional thickness, i.e., about 0.5 mm. In the following description, operations described as being applied to the handle wafer are applied to the handle wafer and all elements currently supported by the handle wafer. Additionally, operations described as being applied to the probe wafer are applied to the probe wafer, the cantilever elements defined in the probe wafer and all layers currently supported by the probe wafer.

In an example, handle wafer 150 is a wafer of single-crystal silicon and the probe wafer is temporarily attached to the handle wafer using clips (not shown). Alternative handle wafer materials include ceramics, sapphire and other suitable materials. In another example, cantilever elements similar to cantilever element 110 are supplied temporarily mounted on a handle wafer.

A sacrificial layer 160 of sacrificial material is deposited with a nominal thickness greater than the distance from handle wafer surface 152 to growth surface 120 so that the sacrificial layer initially covers cantilever element 110, including growth surface 120, as shown in FIG. 8C. In an example, the sacrificial material constituting sacrificial layer 160 is photoresist. The photoresist is deposited on the probe wafer by spin coating to cover cantilever element 110, including cantilever arm 112 and probe tip base 114, as shown in FIG. 8C. The viscosity of the sacrificial material and the spin speed are set to obtain a nominal layer thickness sufficient to cover growth surface 120 with a layer having a nominal thickness of about 100 nm.

Other sacrificial materials that are compatible with the subsequently-performed processing and that can be applied in a manner that produces a planar surface 162 are known in the art and may alternatively be used. As a further alternative, a layer of a material that covers underlying elements conformally may be deposited with a thickness sufficient to cover growth surface 120 to provide sacrificial layer 160. An example of a conformally-covering material is silicon dioxide (SiO₂) deposited by chemical vapor deposition (CVD).

A portion of the sacrificial material constituting sacrificial layer 160 is then removed to form a window 164 that exposes at least part of growth surface 120, as shown in FIG. 8D. The portion of the sacrificial material constituting sacrificial layer 160 that is removed to form window 164 is defined by electron beam lithography. Other lithographic techniques such photolithography and nanoimprint lithography are known in the art and may alternatively be used. The size of window 164 determines the size of the catalyst metal (174 in FIG. 8E) deposited on growth surface 120 and, hence, the diameter of the subsequently-grown nanowire. In an example, window 164 is circular and ranges in diameter from about 5 nm to about 20 nm.

In an example in which photoresist used as sacrificial layer 160, the portion removed to form window 164 is removed by subjecting the probe wafer to the appropriate developer. Directional reactive ion etching or another etching technique can be used to remove any residual sacrificial material remaining on growth surface 120 after the growth surface has been exposed.

In an example in which the sacrificial material constituting sacrificial layer 160 is silicon dioxide, the portion removed to form window 164 is removed by subjecting the probe wafer to a wet etch process using dilute hydrofluoric acid (HF) as etchant. Alternatively, in an example in which the sacrificial material constituting sacrificial layer 160 is silicon dioxide, the portion removed to form window 164 is removed by subjecting the sacrificial material to chemical mechanical polishing (CMP) to expose growth surface 120. However, CMP should not be used to remove the portion of sacrificial layer 160 to form window 164 in the fabrication of functionalizable SPM probe 300 described above with reference to FIGS. 3A and 3B.

The processing described above with reference to FIGS. 8C and 8D typically leaves growth surface 120 covered by a thin layer of native silicon dioxide that, if left in place, would hinder the epitaxial growth of nanowire 130 (FIG. 1A) on growth surface 120. Accordingly, such native oxide layer is removed by subjecting growth surface 120 to an etchant that dissolves silicon dioxide.

In an example, the layer of native silicon dioxide is removed from growth surface 120 by subjecting the probe wafer to a wet etch process using dilute hydrofluoric acid (HF) as the etchant. In another example, the layer of native silicon dioxide is removed by subjecting the probe wafer to a dry etch process using HF vapor as the etchant.

Catalyst metal suitable for catalyzing a vapor-liquid-solid nanostructure growth process is then deposited on the growth surface. FIG. 8E shows a layer 172 of catalyst metal deposited on the surface 162 of sacrificial layer 160 and on the portion of the growth surface 120 of cantilever element 110 exposed by window 164 defined in sacrificial layer 160. The portion of catalyst metal layer 172 deposited on the exposed portion of growth surface 120 is indicated by the reference numeral 174.

The material of catalyst metal layer 172 is a metal capable of catalytically decomposing a gaseous precursor to release a respective constituent element of the nanowire material of nanowire 130 (FIG. 2A). Typical catalyst metals are gold (Au), nickel (Ni), palladium (Pd) and titanium (Ti).

In an example, catalyst metal layer 172 is deposited using electron beam evaporation. Catalyst metal layer may alternatively be deposited by a conventional electroplating process or an electroless plating process.

In another example, galvanic displacement is used to deposit catalyst metal selectively on growth surface 120. In an example in which the catalyst metal is gold, an electrical connection is made to probe tip base 114 via cantilever arm 112 and handle wafer 150, and the probe wafer is placed in a solution of gold potassium cyanide (AuK(CN)₂) or another suitable electrolyte. A suitable anode is also placed in the electrolyte and a current is passed through the electrolyte between the anode and the probe wafer. The silicon of growth surface 120 acts as a reducing agent and the catalyst metal is selectively deposited on the growth surface through a redox mechanism.

The sacrificial material is then removed. Removing the sacrificial material leaves the catalyst metal deposited on the growth surface. FIG. 8F shows cantilever element 110 and handle wafer 150 after sacrificial layer 160 (FIG. 8D) has been removed. Removing sacrificial layer 160 removes the portion of catalyst metal layer 172 located on the surface 162 of the sacrificial layer, but leaves catalyst metal 174 located on the exposed portion of growth surface 120.

In an example, sacrificial layer 160 of photoresist is removed by a lift-off process in which the probe wafer is immersed in acetone ((CH₃)₂CO). Sacrificial layer 160 of silicon dioxide may be removed by subjecting the probe wafer to a wet etch process in which dilute hydrofluoric acid (HF) is used as etchant.

A semiconductor nanowire is then grown extending from the growth surface using the catalyst metal remaining on the growth surface as catalyst. FIGS. 8G and 8H show nanowire 130 being grown extending from growth surface 120 using catalyst metal 174 (FIG. 8F) remaining on the growth surface as catalyst in a vapor-liquid-solid growth process. The growth process is based on that disclosed by Yi in U.S. patent application Ser. No. 10/857,191, incorporated by reference.

In an example, handle wafer 150 is placed on the susceptor 180 of a chemical vapor deposition (CVD) reactor (not shown) and the susceptor and, hence, the handle wafer and the probe wafer, are heated to a deposition temperature near the eutectic point of an alloy between catalyst metal 174 and the nanowire material from which nanowire 130 will be grown. In an example in which catalyst metal 174 was gold and the nanowire material from which nanowire 130 is grown was silicon, the susceptor was heated to a growth temperature of about 450° C.

A growth pressure is established inside the CVD reactor and a gaseous precursor mixture is passed over the probe wafer. In FIG. 8G, the gaseous precursor mixture is represented by solid arrows, an exemplary one of which is shown at 182. Reference numeral 182 will be used to refer to the gaseous precursor mixture. Gaseous precursor mixture 182 is composed of a substantially inert carrier gas and one or more precursors in a gaseous state. The precursors include a precursor for each constituent element of the nanowire material of nanowire 130. In an example in which the nanowire material of nanowire 130 has a single constituent element, such as silicon, gaseous precursor mixture 182 is composed of the carrier gas, a precursor that comprises the single constituent element and, optionally, a precursor for the element with which the semiconductor material is doped. Exemplary precursors for silicon are silane (SiH₄) and disilane (Si₂H₆). Silicon dioxide nanowires are made by annealing silicon nanowires in an oxidizing atmosphere.

In an example in which the bulk semiconductor material of nanowire 130 is a compound semiconductor, i.e., a semiconductor such as gallium arsenide (GaAs) having more than one constituent element, the gaseous precursor mixture is composed of the carrier gas, one or more precursors that collectively comprise the constituent elements of the compound semiconductor. Typically, such gaseous precursor mixture has a different precursor for each constituent element of the compound semiconductor material and the optional dopant. In an example in which the material of nanowire 130 was gallium arsenide, the precursors were trimethyl gallium (TMG) for gallium, arsine (AsH₃) for arsenic. In an example in which the material of nanowire 130 was zinc oxide (ZnO), the precursors were diethylzinc (DEZn) and high-purity oxygen (O₂). In an example in which the material of nanowire 130 was gallium nitride (GaN), the precursors were trimethylgallium (TMGa) and ammonia (NH₃).

Further details of the growth of nanowire 130 will now be described with reference to an example in which the nanowire material of nanowire 130 is a semiconductor having a single constituent element, namely, silicon. The description below can readily be applied to the growth of a nanowire whose nanowire material is a compound semiconductor or a non-semiconductor.

Molecules of the precursor in gaseous precursor mixture 182 that contact catalyst metal 174 (FIG. 8F) are catalytically decomposed by the catalyst metal. Adatoms of the constituent element resulting from the decomposition of the precursor are deposited on the surface 178 of catalyst metal 174. The deposited adatoms mix with catalyst metal 174 to form an alloy, which has a lower melting point than the original catalyst metal. The alloy melts to form catalyst nanoparticle 170 shown in FIG. 8G.

Catalyst nanoparticle 170 is capable of catalytically decomposing the precursors in precursor mixture 182. Consequently, additional adatoms of the constituent element(s) deposited on the surface 176 of catalyst nanoparticle 170 increase the fraction of the constituent element in the alloy until the alloy becomes saturated with the constituent element. Then, further adatoms of the constituent element cause a corresponding number of atoms of the constituent element to be released from catalyst nanoparticle 170 at its surface adjacent growth surface 120. The released atoms grow epitaxially on the growth surface to form a solid nanowire 130 that extends orthogonally from the growth surface.

Further deposition of adatoms of the constituent element on molten catalyst nanoparticle 170 cause the release of additional atoms of the constituent element from the molten catalyst nanoparticle and an increase in the length of nanowire 130, as shown in FIG. 8H. The process of passing gaseous precursor mixture 182 over the probe wafer is continued until nanowire 130 reaches its design length. Molten catalyst nanoparticle 170 remains at the distal end of nanowire 130, remote from growth surface 120, throughout the nanowire growth process and is therefore located at the distal end of nanowire 130 at the end of the growth process.

Nanowire 130 has a lateral surface 132 that, during the growth of the nanowire, is also exposed to gaseous precursor mixture 182. Some of the molecules of the precursor in gaseous precursor mixture 182 contact lateral surface 132 and decompose non-catalytically to deposit respective adatoms of the constituent element on lateral surface 132. Such adatoms accumulate on lateral surface 132. The rate of lengthways growth of nanowire 130 is substantially constant, so the time that an annular segment of lateral surface 132 is exposed to gaseous precursor mixture 182 is inversely proportional to the distance of the annular segment from growth surface 120. Consequently, adatoms accumulated on lateral surface 132 cause the cross-sectional area of nanowire 130 to increase towards growth surface 120. As a result, nanowire 130 has a tapered shape, rather than the non-tapered shape shown. If the taper is not severe, such a tapered shape is acceptable, and may be desirable, in some applications.

In applications in which the non-tapered shape of nanowire 130 shown in FIG. 1A is desirable, i.e., in which nanowire 130 has a uniform cross-sectional area along its length, a gaseous etchant is passed over the growth wafer in addition to precursor mixture 182. The gaseous etchant is represented in FIGS. 8G and 8H by broken arrows 184. Reference numeral 184 will be used to refer to the gaseous etchant. Gaseous etchant 184 removes the adatoms of the constituent element from lateral surface 132 by forming a volatile compound with the adatoms of the constituent element deposited on lateral surface 132. The volatile compound is volatile at the growth temperature and growth pressure established inside the CVD reactor. As the carrier gas that forms part of precursor mixture 182 passes over the probe wafer, it carries the molecules of the volatile compound away from lateral surface 132 into the exhaust system (not shown) of the CVD reactor. The etch rate of the adatoms deposited on lateral surface 132 is several orders of magnitude greater than that of the crystalline material of the lateral surface itself. As a result, the gaseous etchant removes the adatoms but has a negligible etching effect on lateral surface 132.

In an example, gaseous etchant 184 was a halogenated hydrocarbon, such as halogenated methane. In one example, the halogenated methane was carbon tetrabromide (CBr₄). In another example, the halogenated methane was carbon tetrachloride (CCl₄). Not all the hydrogen atoms of the halogenated hydrocarbon need be substituted. Moreover, ones of the hydrogen atoms may be replaced by different halogens. In another example, gaseous etchant 184 was a hydrogen halide (HX), where X=fluorine (F), chlorine (Cl), bromine (Br) or iodine (I).

In another example, gaseous etchant 184 is provided by using a halogen-containing precursor as the precursor for at least one of the constituent elements of the material of nanowire 130. The halogen-containing precursor forms part of gaseous precursor mixture 182 passed over the probe wafer. The halogen-containing precursor is catalytically decomposed at the surface 176 of nanoparticle 170. Adatoms of the constituent element are deposited on surface 176 and the halogen is released into the gaseous precursor mixture. The carrier gas carries the halogen released from the halogen-containing precursor to the lateral surface 132 of nanowire 130 as gaseous etchant 184. Additional halogen may be released by non-catalytic decomposition of the halogen-containing precursor at the lateral surface. At lateral surface 132, the halogen combines with adatoms newly-deposited on the lateral surface to form a volatile compound that the carrier gas carries away from the lateral surface.

The probe wafer in which the functionalizable SPM probes including SPM probe 100 have been fabricated is then detached from handle wafer 150. In an example, the probe wafer in which the functionalizable SPM probes including SPM probe 100 are defined is detached from handle wafer 150 by removing the clips (not shown) holding the wafers together.

In the above description, the probe wafer is detached from handle wafer 150 after nanowire 130 has been grown. Alternatively, the probe wafer can be detached from the handle wafer after sacrificial layer 160 has been removed but before nanowire 130 is grown. In this case, the probe wafer is placed directly on the susceptor 180 (FIG. 8G) of the CVD growth chamber.

In examples of the above process in which the probe wafer lacks apertures extending between its major surfaces, the handle wafer referred to above is unnecessary.

In examples of the above process in which the cantilever elements do not constitute part of a probe wafer, such cantilever elements may be mounted on the handle wafer (FIG. 8B) using double-sided adhesive tape. In an example, the double-sided adhesive tape was based on a polyimide film. After the sacrificial layer has been removed, leaving the catalyst metal on the growth surface, as described above with reference to FIG. 8F, the cantilever elements are removed from the handle wafer by carefully pulling them off the adhesive tape. The cantilever elements are then placed in appropriately-shaped recesses defined in the susceptor of the CVD growth chamber for the nanowire growth process described above with reference to FIGS. 8G and 8H. Alternatively, the cantilever elements may be mounted on the surface of an uncontoured susceptor using small clips.

FIGS. 9A and 9B illustrate part of a process that may alternatively be used to fabricate embodiments of functionalizable SPM probe 100 described above with reference to FIGS. 1A and 1B. This process is a variation on the process described above with reference to FIGS. 8A-8H. The operations described above with reference to FIGS. 8A and 8B are performed. Then, instead of performing the operations described above with reference to FIGS. 8C and 8D to cover the cantilever element with sacrificial material leaving at least part of the growth surface exposed, the operation described next with reference to FIG. 9A is performed. Moreover, instead of performing the operation described above with reference to FIG. 8E to deposit catalyst metal on the growth surface, the operation described next with reference to FIG. 9D is performed. The operations described above with reference to FIGS. 8F-8H are then performed to complete the fabrication of the functionalizable SPM probes.

FIG. 9A illustrates an alternative way of covering the cantilever element with sacrificial material leaving at least part of the growth surface exposed. FIG. 9A shows a sacrificial layer 260 of sacrificial material covering cantilever element 110 leaving growth surface 120 exposed. Sacrificial layer 260 is deposited with a thickness nominally slightly less than the distance from handle wafer surface 152 to growth surface 120 so that growth surface 120 projects from the surface 262 of sacrificial layer 260. Directional reactive ion etching or another etching technique can then be used to remove any sacrificial material from growth surface 120.

In an example, the sacrificial material of sacrificial layer 260 was polymethylmethacrylate (PMMA). The PMMA sacrificial material was deposited by spin coating to cover the probe wafer and cantilever element 110, including cantilever arm 112 and probe tip base 114. The viscosity of the sacrificial material and the spin speed were set to obtain a nominal layer thickness about 100 nm less than the distance from handle wafer surface 152 to growth surface 120 so that the deposition process leaves growth surface 120 exposed. Sacrificial layer 260 of PMMA is later removed in the operation described above with reference to FIG. 8F by a lift-off process in which the probe wafer is immersed in acetone ((CH₃)₂CO).

Photoresist deposited by spin coating may be used instead of PMMA as the sacrificial material of sacrificial layer 260. Other materials that are compatible with the subsequently-performed processing and that can be applied in a manner that produces a planar surface 262 are known in the art and may alternatively be used as the sacrificial material of sacrificial layer 260.

FIG. 9B illustrates an alternative way of depositing catalyst metal suitable for catalyzing a vapor-liquid-solid nanostructure growth process on the exposed growth surface. FIG. 9B shows nanoparticles of catalyst metal deposited on the surface 262 of sacrificial layer 260 and on growth surface 120 at the distal end of probe tip base 114, remote from cantilever arm 112. The fraction of the area of the surface 262 of sacrificial layer 260 occupied by growth surface 120 is very small. The nanoparticles of catalyst metal are applied at such an area density that, on average, more than zero but no more than one nanoparticle 274 of catalyst metal is located on growth surface 120. Examples of the nanoparticles of catalyst metal located on the surface 262 of sacrificial layer 260 are shown at 272.

The catalyst metal constituting nanoparticles 272 and 274 is one capable of catalytically decomposing a gaseous precursor to release a respective constituent element of the semiconductor material of which nanowire 130 (FIG. 1A) will be grown. Typical catalyst nanoparticles are nanoparticles of gold (Au), nickel (Ni), palladium (Pd) or titanium (Ti).

The size of nanoparticle 274 determines the diameter of nanowire 130 (FIG. 1A). In an example, the catalyst nanoparticles had an average diameter in the range from about 5 nm to about 20 nm.

In an example, a solution containing colloidal nanoparticles of catalyst metal is spun onto the surface 262 of sacrificial layer 260. Handle wafer 150 is then gently heated to evaporate the liquid component of the colloidal solution. This leaves nanoparticle 274 located on growth surface 120 and nanoparticles 272 distributed over the surface 262 of sacrificial layer 260. In another example, an aqueous solution of colloidal nanoparticles of catalyst metal is mixed with methanol (CH₃OH) and the resulting mixture is dropped onto the surface 262 of sacrificial layer 260. The mixture rapidly spreads over surface 262 and growth surface 120. The handle wafer is then gently heated to evaporate the liquid component of the dilute colloidal solution. This leaves nanoparticle 274 located on growth surface 120 and nanoparticles 272 distributed over surface 262 of sacrificial layer 260.

The operations described above with reference to FIGS. 8F-8H are then performed. Removing sacrificial layer 262 in the operation described above with reference to FIG. 8F removes all of the nanoparticles 272 of catalyst metal located on the surface 262 of the sacrificial layer, but leaves nanoparticle 274 of catalyst metal located on growth surface 120. Sacrificial layer 260 of PMMA is removed by a lift-off process in which the probe wafer is immersed in acetone ((CH₃)₂CO).

FIG. 10 illustrates part of a process that may be used to fabricate embodiments of functionalizable SPM probe 100 described above with reference to FIGS. 1A and 1B or functionalizable SPM probe 300 described above with reference to FIGS. 3A and 3B. This process is a variation on the process described above with reference to FIGS. 8A-8H. The operations described above with reference to FIGS. 8A-8D are performed. Then, instead of performing the operation described above with reference to FIG. 8E, the operation described next with reference to FIG. 10 is performed. The operations described above with reference to FIGS. 8F-8H are then performed to complete the fabrication of the functionalizable SPM probes.

FIG. 10 illustrates an alternative way of depositing catalyst metal suitable for catalyzing a vapor-liquid-solid growth process on the growth surface. FIG. 10 shows nanoparticles of catalyst metal deposited on the surface 162 of sacrificial layer 160 and on growth surface 120 at the distal end of probe tip base 114, remote from cantilever arm 112. Growth surface 120 is exposed by removing a region of sacrificial layer 160 to form a window 164, as described above with reference to FIG. 8D. The area of window 164 represents a very small fraction of the area of the surface 162 of sacrificial layer 160. The nanoparticles of catalyst metal are applied at such an area density that, on average, more than zero but no more than one nanoparticle 274 is located in the window 164 that exposes growth surface 120. Examples of the nanoparticles of catalyst metal located on the surface 162 of sacrificial layer 160 are shown at 272. The properties of nanoparticles 272 and 274 and methods for depositing the nanoparticles are described above with reference to FIG. 9B.

The operations described above with reference to FIGS. 8F-8H are then performed. Removing sacrificial layer 162 in the operation described above with reference to FIG. 8F removes all of the nanoparticles 272 of catalyst metal located on the surface 162 of the sacrificial layer, but leaves nanoparticle 274 of catalyst metal located on growth surface 120.

This disclosure describes the invention in detail using illustrative embodiments. However, the invention defined by the appended claims is not limited to the precise embodiments described.

We claim:

1. A functionalized scanning probe microscopy (SPM) probe, comprising:
a cantilever element comprising a crystalline growth surface at one end thereof;
a nanowire extending substantially orthogonally from the growth surface;
a catalyst nanoparticle at a distal end of the nanowire, remote from the growth surface;
a probe molecule; and
an elongate, flexible linking molecule extending between the catalyst nanoparticle and the probe molecule.

2. The functionalized SPM probe of claim 1, in which:
the linking molecule comprises a bonding moiety at the one end thereof;
the functionalized SPM probe additionally comprises coating molecules each comprising a bonding moiety, the coating molecules being shorter than the linking molecule; and
the catalyst nanoparticle is coated with a self-assembled monolayer comprising the coating molecules and the linking molecule.

3. The functionalized SPM probe of claim 1, in which:
the nanowire comprises nanowire material; and
the catalyst nanoparticle comprises a material having a greater tendency to bond with the bonding moieties than the nanowire material.

4. The functionalized SPM probe of claim 1, in which the linking molecule comprises a linear polymer.

5. The functionalized SPM probe of claim 4, in which:
the linking molecule comprises a bonding moiety at the one end thereof; and
the bonding moiety comprises one of a thiol group (—SH), a disulfide group (—S—S—R), a selenol group (—SeH) and a diselenide (—Se—Se—R) group, in which R is any alkyl chain or aromatic group.

6. The functionalized SPM probe of claim 1, comprising no more than one probe molecule.

7. A method, comprising:
providing a scanning probe microscopy (SPM) probe comprising a cantilever element having a crystalline growth surface at one end thereof, a nanowire extending substantially orthogonally from the growth surface, and a catalyst nanoparticle at a distal end of the nanowire, remote from the growth surface; and
coupling a probe molecule to the catalyst nanoparticle by an elongate, flexible linking molecule attached at one end to the catalyst nanoparticle and attached at another end, remote from the one end, to the probe molecule.

8. The method of claim 7, in which the coupling comprises:
providing a solution comprising the elongate, flexible linking molecule; and
dipping the distal end of the nanowire and the catalyst nanoparticle into the solution to cause the one end of the linking molecule to attach to the catalyst nanoparticle.

9. The method of claim 8, in which the solution additionally comprises the probe molecule attached to the other end of the linking molecule.

10. The method of claim 8, in which the coupling additionally comprises attaching the probe molecule to the other end of the linking molecule.

11. The method of claim 8, in which the solution additionally comprises coating molecules, the coating molecules being shorter than the linking molecule.

12. The method of claim 11, in which:
the linking molecule comprises a first bonding moiety at the one end thereof; and
the coating molecules each comprise a second bonding moiety.

13. The method of claim 7, additionally comprising:
providing coating molecules, the coating molecules being shorter than the linking molecule; and
prior to the coupling, coating the catalyst nanoparticle with the coating molecules.

14. The method of claim 13, in which:
the linking molecule comprises a first bonding moiety at the one end thereof; and
the coating molecules each comprise a second bonding moiety.

15. The method of claim 14, in which the second bonding moiety is the same as the first bonding moiety.

16. The method of claim 7, in which the linking molecule comprises a linear polymer molecule.

17. The method of claim 16, in which the linking molecule additionally comprises a bonding moiety comprising one of a thiol group (—SH), a disulfide group (—S—S—R), a selenol group (—SeH) and a diselenide group (—Se—Se—R), in which R is any alkyl chain or aromatic group.

18. A method, comprising:
providing a scanning probe microscope;
providing a scanning probe microscopy (SPM) probe comprising a cantilever element having a crystalline growth surface at one end thereof, a nanowire extending substantially orthogonally from the growth surface, a catalyst nanoparticle at a distal end of the nanowire, remote from the growth surface, a probe molecule and an elongate, flexible linking molecule extending between the catalyst nanoparticle and the probe molecule;
mounting the SPM probe in the scanning probe microscope; and
using the scanning probe microscope with the mounted SPM probe to perform a molecular recognition imaging operation on a sample comprising a molecule of interest capable of selectively interacting with the probe molecule.

19. The method of claim 18, additionally comprising using the scanning probe microscope with the mounted SPM probe to measure topography of the sample.

20. The method of claim 19, additionally comprising simultaneously performing the molecular recognition imaging operation and the topography measurement.

21. A scanning probe microscopy (SPM) probe functionalizable for use in molecular recognition imaging, the probe comprising:
a cantilever element comprising a crystalline growth surface at one end thereof;
a nanowire extending substantially orthogonally from the growth surface, the nanowire comprising nanowire material; and
a catalyst nanoparticle at a distal end of the nanowire, remote from the growth surface, the catalyst nanoparticle comprising a material having a greater tendency to bond with one end of an elongate, flexible linking molecule than the nanowire material.

22. The functionalizable SPM probe of claim 21, in which the cantilever element comprises:
a cantilever arm; and
a frusto-pyramidal probe tip base at an end of the cantilever arm, the probe tip base comprising a crystalline end facet at an end thereof remote from the cantilever arm, the end facet providing the crystalline growth surface.

23. The functionalizable SPM probe of claim 21, in which:
the cantilever element comprises a cantilever arm, the cantilever arm comprising single-crystal semiconductor material; and
at least part of the semiconductor material provides the crystalline growth surface.
